(19) United States
(12) Patent Application Publication
(10) Pub. No.: US 2025/0299490 A1
(43) Pub. Date: Sep. 25, 2025

(54) Monitoring Work of An Agricultural Machine

(71) Applicant: DEERE & COMPANY, Moline, IL (US)

(72) Inventors: JAN CHRISTOPH PETERS, Kaiserslautern (DE); CRISTIAN DIMA, Mainz (DE)

(21) Appl. No.: 19/084,865

(22) Filed: Mar. 20, 2025

(30) Foreign Application Priority Data
Mar. 22, 2024 (DE) 102024108292.5

(51) Int. Cl. G06V 20/52; G06V 10/44; G06V 20/10; G06V 20/40

(52) U.S. Cl. CPC G06V 20/52; G06V 10/44; G06V 20/188; G06V 20/44

(57) ABSTRACT

An apparatus for monitoring an agricultural work machine, comprising: at least one sensor configured to record a work process of the agricultural work machine and generate an image signal based thereon; and an evaluation device configured to evaluate the image signal of the sensor based on comparison values and to generate an output value in the event of a detected problem, the evaluation device further configured with a deep learning network to detect anomalies in the image signal.

### RELATED APPLICATIONS

This document claims priority based on German Patent Application No. 102024108292.5, filed on Mar. 22, 2024, which is hereby incorporated by reference into this application.

### DESCRIPTION

The present disclosure relates to a method, apparatus and system for monitoring work of an agricultural machine.

### BACKGROUND

In agriculture, control and monitoring tasks are increasingly being automated to make work easier for the operator of an agricultural work machine or to allow such machines to work autonomously. Sensors are therefore used to record a work process and/or the result thereof and to generate electronic signals that are fed to an evaluation device. The work process can, for example, be the introduction of crop using a harvesting header and the crop flow can be monitored when the crop is received, and within the harvesting header, or the stubble remaining in the field is monitored as the work result. The sensors often used are electro-optical sensors, i.e. cameras or scanning sensors (lidar, etc.) that monitor the work process. The evaluation device is configured to use the signals fed to it to recognize whether the work process is being carried out correctly or not, and in the second case to emit a corresponding error signal. In the simplest case, this error signal can be relayed to an operator to inform them of a detected problem so that they can take appropriate measures to rectify the problem. In advanced approaches, the evaluation device can also monitor actuators and activate them to prevent or moderate the problem.

### BRIEF DESCRIPTION

An apparatus for monitoring an agricultural work machine, comprising: at least one sensor configured to record a work process of the agricultural work machine and generate an image signal based thereon; and an evaluation device configured to evaluate the image signal of the sensor based on comparison values and to generate an output value in the event of a detected problem, the evaluation device further configured with a deep learning network to detect anomalies in the image signal.

A method for an agricultural work machine, comprising the steps of: recording with a sensor the work process; generating an image signal based on the work process; evaluating, with an evaluation device, the image signal of the sensor based on comparison values; configuring the evaluation device with a deep learning network which detects anomalies in the supplied image signals; and generating, with the evaluation device, an output value in the event of a detected problem.

A system for monitoring an agricultural work machine, comprising: a camera configured to record an image of the crop a work process of the agricultural work machine and generate an image signal based thereon; and an image processing system configured to evaluate the image signal of the sensor based on comparison values and to generate an output value in the event of a detected problem, the image processing system further configured with a deep learning network to detect anomalies in the image signal.

### DRAWINGS

The above-mentioned aspects of the present disclosure and the manner of obtaining them will become more apparent and the disclosure itself will be better understood by reference to the following description of the examples of the disclosure, taken in conjunction with the accompanying drawing, wherein:

FIG. 1 shows a top view of a harvesting machine according to a first example,

FIG. 2 shows a diagram for the signal evaluation of the sensors for monitoring the sectional image of the harvesting header of the harvesting machine of FIG. 1,

FIG. 3 shows a top view of a harvesting machine according to a second example.

### DETAILED DESCRIPTION

One difficulty that arises is automatically recognizing whether the work process of an agricultural work machine is being carried out correctly. It is problematic to enable reliable detection under all or as many operating conditions as possible. In addition, different work processes to be monitored also require different procedures for monitoring.

In one approach, for example, European Patent No. EP 2 143 316 A1 describes monitoring a harvesting header in which flow problems of the material within the harvesting header are supposed to be detected based on a lack of motion blur or comparisons of images taken in immediate succession or by comparison with reference images. European Patent No. EP 2 545 761 A1 also describes a comparison between captured images and reference images for observing the soil of the field directly behind a cutting unit. According to European Patent No. EP 3 150 047 A1, certain objects in the crop flow are identified and the movement thereof between consecutively captured images is recorded to determine the optical flow, and European Patent No. EP 3 300 019 A1 proposes calculating an optical flow using the Lucas-Kanade method to evaluate the crop flow within a cutting unit.

Accordingly, deterministic algorithms are used that are specifically adapted to the respective application and are intended to recognize characteristic features, for problems that occur. This means that complex programming is required for each application, which requires many adjustments to threshold values and parameters that prove to be time-consuming and do not always lead to reliable functioning of the algorithm. The problem in the present case is to improve an electro-optical sensor system for an agricultural vehicle in such a way that the disadvantages mentioned are avoided or at least reduced.

An arrangement for monitoring a work process in an agricultural work machine and/or the result thereof comprises at least one electro-optical sensor which is arranged to optically record the work process and/or the result thereof and to generate an image signal based thereon, and an evaluation device which is configured to evaluate the image signal of the electro-optical sensor based on comparison values and to generate an output value in the event of a detected problem, wherein the evaluation device comprises a deep learning network which is configured to detect anomalies in the supplied image signals or to facilitate their detection.

In other words, instead of using an algorithm specifically adapted to the work process to be monitored and/or the result thereof, a so-called deep learning network is used, which contains an adaptive neural network with a sufficiently large number of neural layers. This network is trained in such manner that it can distinguish between normal situations and anomalies or at least facilitates the detection of anomalies by pre-processing the image signal to extract certain features or feature vectors from it, which are further analyzed in a subsequent step by a downstream algorithm to detect anomalies, e.g. by a nearest neighbor classification. With the latter variant, training of the network could in principle be dispensed with. This eliminates the need for complex programming of algorithms and adaptation to the respective application, as it is sufficient when the appropriately trained deep-learning network recognizes if the image signal represents an anomalous situation.

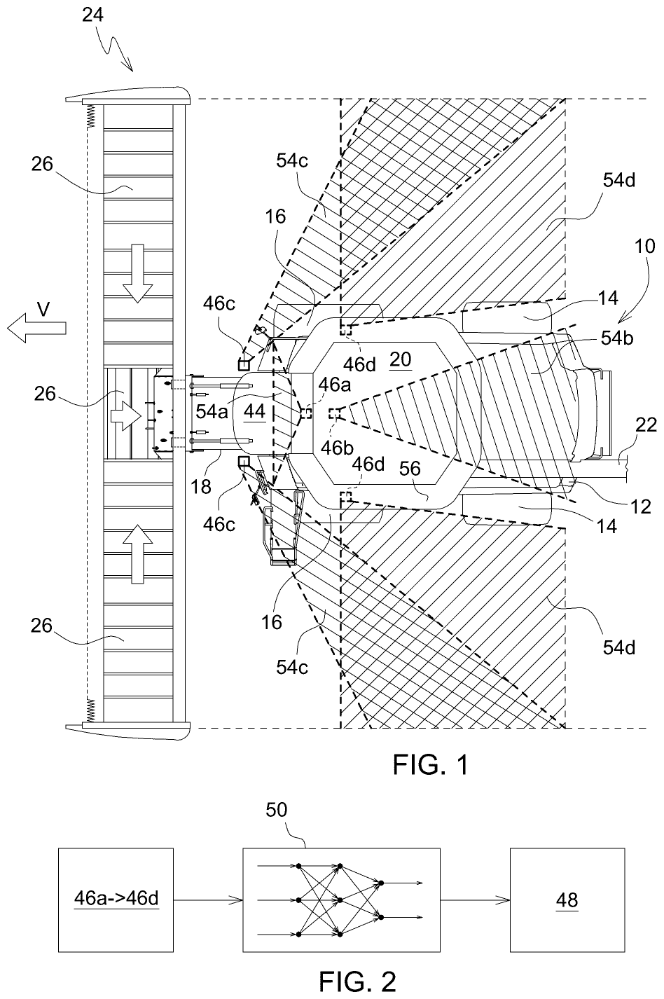

FIG. 1 shows an agricultural harvesting machine 10 in the form of a combine harvester having a supporting structure 12 provided with rear steerable wheels 14 engaging with the ground and front driven wheels 16 which, in operation, move the harvesting machine 10 in a forward direction V over a field to be harvested. Although the combine harvester 10 is represented with wheels 14, 16, it could also be provided with two or four crawler tracks. A harvesting header 24 is used to harvest crop and feeds it to a feeder house 18, which conveys it into the interior of the harvesting machine 10, where it is threshed, separated and cleaned in a manner known per se. The clean grain is ultimately deposited in a grain tank 20, from which it can be transferred to a transport vehicle by an unloading conveyor 22. Instead of on a combine harvester 10, the sensor system and evaluation device 50 described here could also be used on a forage harvester equipped with a harvesting header in the form of a corn header or collector or on any other harvesting machine to monitor the field after the process of picking up the crop. Furthermore, the sensor system and evaluation device 50 described throughout the present document are also suitable for other applications in which agricultural work processes and/or the results thereof are intended to be monitored, such as tillage equipment, seed drills, etc. (possible applications are described in German Patent No. DE 10 2005 005 557 A1, the disclosure of which is incorporated by reference into the present documents).

The harvesting header 24 is configured as a cutting unit with a cutter bar 30, cross conveyor belts 26 and a central conveyor belt 28 that conveys to the rear. A reel, not shown in FIG. 1, is arranged above the conveyor belts 26, 28. Instead of the cross-conveyor belts 26, 28 or in addition thereto, a cross-conveyor screw could be used for cross transport of the crop and for delivery into the feeder house 18.

In order to automatically detect any problems when picking up the crop from the field and, if necessary, to warn the operator in the cabin 44 and/or to be able to take countermeasures automatically, the harvesting machine 10 is provided with a number of electro-optical sensors 46a, 46b, 46c, 46d, which are configured as cameras and look downwards from the harvesting machine 10. The sensors 46a, 46b, 46c, 46d are attached to the harvesting machine 10 and connected to an evaluation device 50 (see FIG. 2), which in turn is connected to a display device 48 located in the cabin 44 in the field of vision of the driver located at their workstation. The sensors 46a, 46b, 46c, 46d record images of the field to the rear of the harvesting header 16, i.e. the soil of the field and the stubble thereon, any crop that may have been left lying behind and lost grains that reach the field in the event of an undesired threshing action of the harvesting header 16 (i.e. in the event of an unfavorable setting of a working parameter of the reel). The images of the sensors 46a, 46b, 46c, 46d are displayed on the display device 48 and make it easier for the driver to monitor the cutting process of the cutting device 40 and to detect possible errors in the setting of working parameters of the harvesting header 16. Alternatively or additionally, the control device 50 can automatically set one or a plurality of working parameters of the harvesting header 16, e.g. the rotational speed, vertical position and/or horizontal position of the reel 28 and the height of the harvesting header 16 above the ground, based on the signals of one or a plurality of the sensors 46a, 46b, 46c, 46d, for which reference is made according to European Patent No. EP 2 545 761 A1.

A first sensor 46a is attached to the front of the front axle 52, which supports the front wheels 15 on the supporting structure 12. It looks forward and downwards and covers an approximately trapezoidal region 54a of the field in front of the front axle 52 and to the rear of the front edge of the front wheels 16, i.e. the region of the field traversed by the feeder house 18, as shown in FIG. 1. The region 54a could also extend to the rear of the harvesting header 24.

A second sensor 46b is attached to the rear of the front axle 52. It looks backwards and downwards and covers an approximately trapezoidal region 54b of the field to the rear of the front axle 52, which extends backwards to behind the rear wheels 14, as shown in FIG. 1. The second sensor 46b also records crop residues discharged by a residue processing system 58 of the harvesting machine. Its signals can be evaluated by the control device 50 and, if necessary, used to adjust the working parameters of the residue processing system 58 automatically or by way of the driver, e.g. guide plates or rotational speeds of crop residue distributors. The chopped material lengths can also be recorded and used to readjust the counter-blades and/or rotational speeds of the straw chopper.

On each side of the harvesting machine 10 is attached a third sensor 46c, which (differently to what is shown) could be attached to the rear-view mirror. Accordingly, the third sensor 46c is mounted in the upper, front region of the roof of the cabin 44 and looks from there obliquely backwards and downwards, so that it covers an approximately triangular region 54c of the field laterally next to the harvesting machine 10, as shown in FIG. 1.

On each side of the harvesting machine 10 is attached a fourth sensor 46d, which is mounted on a side covering of the harvesting machine 10 below a grain tank attachment 56 and looks from there obliquely backwards and downwards, so that it covers an approximately triangular region 54d of the field laterally next to the harvesting machine 10, as shown in FIG. 1. Further details can be found in German Patent No. DE 10 2019 207 984 A1, the entire disclosure of which is incorporated by reference into the present documents.

The sensors 46a-46d therefore monitor the field after the harvesting header 24 has cut the crop. Alternatively, or additionally, an electro-optical sensor according to European Patent No. EP 2 545 761 A1 could also be used, which monitors the region of the ground directly behind the harvesting header 24 and in front of the wheels 16. The sensors 46d could also cover a region 54d that extends symmetrically to the transverse axis, possibly up to the rear of the harvesting header 24 and up to the rear wheels 14.

The evaluation device 50 thus has the task of detecting any problems that arise when picking up the crop from the field. For this purpose, traces are identified in the image signals of the electro-optical sensors 46a-46d, which are probably caused by problems with the harvesting header 24. Such problems could be, for example, that the harvesting header 24 is guided too low over the ground and digs into it, that there are problems with the cutter bar 30 (blunt or broken blades) which result in plants not yet cut standing or lying behind the harvesting header 24, that crops are pushed in front of the harvesting header 24 and ultimately remain lying in the field, or that, in the case of stored grain, the height of the harvesting header 24 is too low to pick up the entire crop.

Regarding the appearance in the image signal of the electro-optical sensors 46a-46d, these traces can be considered anomalies, since they and the situations that lead to them occur relatively rarely. The present approach therefore leads to the field of anomaly detection and the use of deep learning. For this purpose, a neural network is used which is trained beforehand (basic introductions for this can be found, for example, in European Patent No. EP 0 586 999 A1 and European Patent No. EP 1 529 428 A1, the entire disclosures of which are incorporated by reference into the present documents), and deep learning uses such neural networks which have a sufficient number of layers. The approach consists of two main steps:
(a) A trained model for deep learning is used for dimension reduction by extracting features or feature vectors from the input images.
(b) In the (lower-dimensional) feature space, classic methods for anomaly detection are used, such as clustering or probability density estimation.

Classic methods for anomaly detection, such as those used in step (b), have long been known among experts. Examples include: local outlier factor (Breunig et al. (2000): “Identifying Density-based Local Outliers”), isolation forests (Liu et al. (2008): “Isolation Forest”), one-sided SVMs (Schölkopf et al. (2001): “Estimating the Support of a High-dimensional Distribution”), k-Nearest Neighbor (Knorr et al. (2000): “Distance-based outliers: Algorithms and Applications”), and Kernel Density Estimation (see for example Bishop, Christopher M. (1996). Neural Networks for Pattern Recognition). It is also well known that many of these methods are not suitable for very high-dimensional feature spaces (see “curse of dimensionality” in Bishop, op. cit.). To circumvent this problem, the idea is used that trained models can be used for dimension reduction, i.e. transforming high-dimensional inputs into lower-dimensional outputs that can still meaningfully represent the content or the important features of the original input.

Accordingly, in step (a), the neural deep learning network of the evaluation device 50 extracts feature vectors from the image signals and, in step (b), the evaluation device 50 (i.e. not the deep learning network), in particular using one of the methods mentioned in the previous paragraph, determines the distance between the currently calculated feature vectors and feature vectors representing normal working operation (the latter may be known, stored values or those which are recorded during ongoing, trouble-free working operation, i.e. the evaluation device 50 detects sudden changes in the recorded feature vectors). The evaluation device 50 is configured to monitor the time progression of the distance in step (b) and to generate the output value based on the time progression. In addition, the evaluation device 50 can be configured to match the features representing normal working operation to the respective working operation. For example, this can involve considering when external circumstances of working operation change, e.g. in the headland or when changing to another field, to avoid false alarms if necessary. The detection of anomalies can therefore be suspended for a certain period after the external circumstances change or be carried out with a higher threshold than usual. If an anomaly is detected, an operator receives a corresponding message via an interface and/or actuators are activated automatically with a view to rectifying the anomaly.

### Second Example, Monitoring of the Harvesting Header

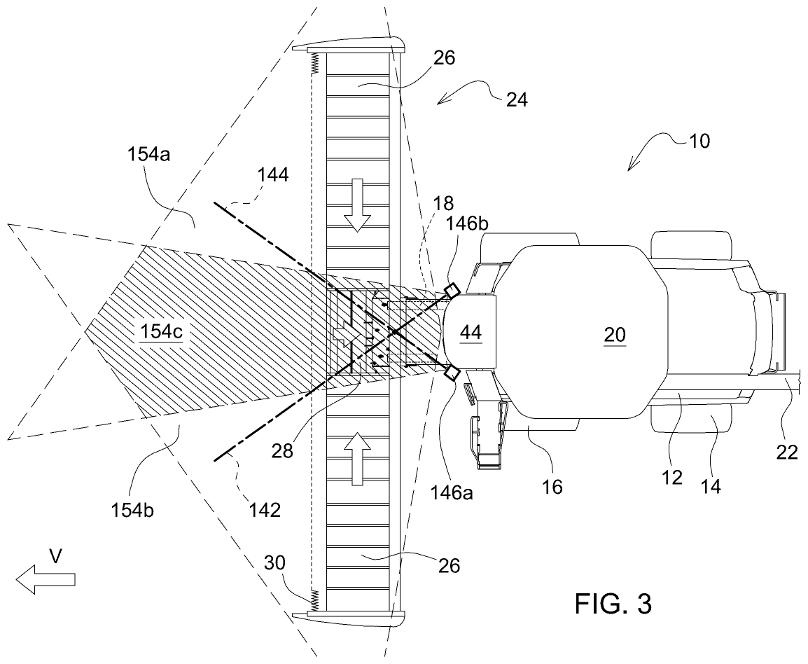

FIG. 3 shows an agricultural harvesting machine 10 in the form of a combine harvester, the design of which corresponds to that of the harvesting machine 10 of FIG. 1. However, the crop flow is monitored here within the harvesting header 24. On the front corners of the roof of the cabin 44 of the harvesting machine 10 is attached a sensor arrangement, which comprises a first electro-optical sensor 146a and a second electro-optical sensor 146b, each of which can be monocular or stereo cameras. The first sensor 146a has a (conical or pyramid-shaped) field of view 154a with an optical axis 144. The second sensor 146b has a (conical or pyramid-shaped) field of view 154b with an optical axis 142.

The first sensor 146a is attached to the front left corner of the roof of the cabin 44 in the forward direction V, and its optical axis 144 is inclined obliquely downwards and forwards, but is aligned obliquely to the right with respect to the forward direction V. The second sensor 146b is attached to the front right corner of the roof of the cabin 44 in the forward direction V and its optical axis 142 is inclined obliquely downwards and forwards, but is aligned obliquely to the left with respect to the forward direction V. The optical axes 144, 142 are aligned mirror-symmetrically to the vertical longitudinal center plane of the harvesting machine 10 and are each inclined downwards to the same extent. The optical axes 142, 144 therefore cross at a point P, which is located in front of the sensors 146a, 146b.

Accordingly, the sensors 146a, 146b are arranged further away from the regions to be examined, which are the crop in front of the harvesting header 24 and/or the harvesting header 24, than if their optical axes 142, 144 were aligned exactly to the front or the axis 144 of the first sensor 146a were directed to the left and the axis 142 of the second sensor 146b to the right. In the center in front of the harvesting header, there is an overlap region 154c of the regions 154a, 154b observed by the sensors 146a, 146b, which allows for more robust measurements there than when observed using only a single sensor 146a or 146c, and there is a simplified way to position the sensors relative to each other by comparing their images.

The signals from the sensors 146a, 146b are evaluated by the arrangement according to FIG. 2, wherein the sensors 146a, 146b replace the sensors 46a-46d shown there. The evaluation device 50 activates the display device 48 to display suitable images on which the operator can see, on the one hand, the crop in front of the harvesting header 24 and, on the other hand, also the harvesting header 24 and can monitor the function of the harvesting header, wherein any detected problems, such as wrapping of the crop around the reel (cf. European Patent No. EP 3 552 474 A1) or cross conveying problems, can be visually highlighted. Additionally, or alternatively, one or a plurality of actuators can be activated depending on the signal from the sensors 146a, 146b, for example to control the advancing speed of the harvesting machine 10 depending on the crop density and/or to steer the harvesting header 24 along a crop edge. The setting of working parameters of the harvesting header (reel position in horizontal and vertical direction, cutting table length, cutting height, etc.) can also be controlled automatically by the evaluation device 50 using the signal from the sensors 146a, 146b.

It is intended to monitor the continuous crop flow within the harvesting header 24 (between the reel and the rear of the harvesting header 24) in the direction of the feeder house 18 and into the harvesting machine 10. If this continuous flow slows down or stops, a problem within the harvesting header 24 may be the cause and the operator should be informed about it. The reasons for these problems can be either external reasons (such as soil having high moisture, leading to crop being pushed) or self-induced (sub-optimal settings for the reel, cutting table or conveyor belts).

Monitoring a flow or movement of objects in an image sequence prompts a person skilled in the art to think of either sparse or dense tracking approaches, both of which essentially try to detect and track the movement of intensity patterns over a sequence of individual frames. While sparse approaches follow a few easily recognizable and trackable optical features, dense tracking approaches try to calculate the direction and speed of the movement of all pixels in an image (the optical flow), i.e. the movement of the entire scene at the largest possible granularity. It is important to note that dense approaches usually require a relatively high refresh rate to work.

Approaches in this area are normally based on explicit problem-specific equations and associated solution paths, such as Lucas-Kanade, see for example European Patent No. EP 3 300 019 A1 or European Patent No. EP 3 593 616 A1. However, deep learning has been proven to be an alternative way to solve such problems, wherein a deep model with many parameters (in the order of millions) is trained with (temporally consecutive) input image pairs and the resulting flow to be calculated. Training a deep model of this kind is substantially a mathematical optimization in which the parameters of the model are adjusted so that the output value produced by the model for a given input image pair is as close as possible to the target output value corresponding to the training data.

The performance and quality of deep models of this kind in general and especially for recording movements have reached a high level, so that deep learning can be considered a superior alternative to classic calculation methods. One example to mention here would be a method known as RAFT (Z. Teed et al., [2003.12039] RAFT: Recurrent All-Pairs Field Transforms for Optical Flow (arxiv.org)). Test results have shown that these deep learning-based approaches can even outperform the classic approaches in terms of the accuracy and quality of the output values, albeit possibly at the cost of higher computing power.

The following algorithm is used to detect problems in the crop flow. The optical flow is not calculated, but the approach proceeds in a similar way to monitoring the stubble image (first example above), i.e. based on pre-trained deep learning models as feature extractors and on anomaly detection. Unlike the first example, a trained model for dimension reduction is used here, which is based on image sequences or image pairs as inputs, and which encodes the dynamics in the given scene in corresponding intermediate results. The rest of the approach is as above (first example): A suitable deep learning model is used for dimension reduction of the image pairs or sequences, and a classic anomaly detection algorithm is applied in the feature space with the resulting features.

The algorithm for detecting crop flow problems therefore does not calculate the optical flow, but uses ideas like those for stubble monitoring, i.e. based on anomaly detection and using pre-trained deep learning models as feature extractors. The feature vectors generated in this way are tracked over time and an anomaly is detected in case of sudden changes. In the event of an anomaly being detected, the further approach corresponds to the first example.

Those skilled in the art will recognize that it is common within the art to implement apparatuses and/or devices and/or processes and/or systems in the fashion(s) set forth herein, and thereafter use engineering and/or business practices to integrate such implemented apparatuses and/or devices and/or processes and/or systems into more comprehensive apparatuses and/or devices and/or processes and/or systems. That is, at least a portion of the apparatuses and/or devices and/or processes and/or systems described herein can be integrated into comprehensive apparatuses and/or devices and/or processes and/or systems via a reasonable amount of experimentation.

Although the present disclosure has been described in terms of specific examples and applications, persons skilled in the art can, considering this teaching, generate additional examples without exceeding the scope or departing from the spirit of the present disclosure described herein. Accordingly, it is to be understood that the drawings and description in this disclosure are proffered to facilitate comprehension of the present disclosure and should not be construed to limit the scope thereof.

As used herein, unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

It should also be noted that the different examples described herein can be combined in different ways. That is, parts of one or more examples can be combined with parts of one or more other examples. All of this is contemplated herein.

1. An apparatus for monitoring an agricultural work machine, comprising:
at least one sensor configured to record a work process of the agricultural work machine and generate an image signal based thereon; and
an evaluation device configured to evaluate the image signal of the sensor based on comparison values and to generate an output value in the event of a detected problem, the evaluation device further configured with a deep learning network to detect anomalies in the image signal.

2. The apparatus of claim 1 wherein the deep learning network is configured to extract feature vectors from the image signals.

3. The apparatus of claim 2 wherein the evaluation device is configured to determine the distance of the extracted feature vectors from feature vectors representing normal working operation to detect anomalies.

4. The apparatus of claim 3 wherein the evaluation device is configured to monitor the time progression of the distance and to generate the output value based on the progression.

5. The apparatus of claim 4 wherein the evaluation device is configured to match the features representing normal working operation to the respective working operation.

6. The apparatus of claim 1 wherein the work process is a harvesting process performed with a harvesting header of a harvesting machine.

7. The apparatus of claim 6 wherein the sensor records the soil of a field harvested with the harvesting header after the harvesting process.

8. A method for an agricultural work machine, comprising the steps of:
recording with a sensor the work process;
generating an image signal based on the work process;
evaluating, with an evaluation device, the image signal of the sensor based on comparison values;
configuring the evaluation device with a deep learning network which detects anomalies in the supplied image signals; and
generating, with the evaluation device, an output value in the event of a detected problem.

9. The method of claim 8 further comprising the step of extracting, with the deep learning network, feature vectors from the image signals.

10. The method of claim 9 further comprising the step of determining, with the evaluation device, the distance of the extracted feature vectors from feature vectors representing normal working operation to detect anomalies.

11. The method of claim 10 wherein the evaluation device is configured to monitor the time progression of the distance and to generate the output value based on the progression.

12. The method of claim 11 wherein the evaluation device is configured to match the features representing normal working operation to the respective working operation.

13. The method of claim 8 wherein the work process is a harvesting process performed with a harvesting header of a harvesting machine.

14. The method of claim 13 wherein the sensor records the soil of a field harvested with the harvesting header after the harvesting process.

15. A system for monitoring an agricultural work machine, comprising:
a camera configured to record an image of the crop a work process of the agricultural work machine and generate an image signal based thereon; and
an image processing system configured to evaluate the image signal of the sensor based on comparison values and to generate an output value in the event of a detected problem, the image processing system further configured with a deep learning network to detect anomalies in the image signal.

16. The system of claim 16 wherein the deep learning network is configured to extract feature vectors from the image signals.

17. The system of 17 wherein the image processing system is configured to determine the distance of the extracted feature vectors from feature vectors representing normal working operation to detect anomalies.

18. The system of claim 17 wherein the image processing system is configured to monitor the time progression of the distance and to generate the output value based on the progression.

19. The system of claim 18 wherein the image processing system is configured to match the features representing normal working operation to the respective working operation.

20. The system of claim 15 wherein the work process is a harvesting process performed with a harvesting header of a harvesting machine and the camera records the soil of a field harvested with the harvesting header after the harvesting process.
